(19) United States
(12) Patent Application Publication
(10) Pub. No.: US 2005/0079476 A1
(43) Pub. Date: Apr. 14, 2005

(54) Method of predictive assessment

(76) Inventors: Scot M. Sutherland, Lancaster, CA (US); Stephen Shireman, Kansas City, MO (US)

Correspondence Address: THOMAS B. LUEBBERING;HOVEY WILLIAMS LLP, Suite 400, 2405 Grand, Kansas City, MO, 64108, US

(21) Appl. No.: 10/744,274

(22) Filed: Dec. 23, 2003

Related U.S. Application Data
(60) Provisional application No. 60/510,692, filed on Oct. 10, 2003.

(51) Int. Cl. G09B 19/00; G09B 7/00

(52) U.S. Cl. 434/323; 434/362; 434/236

(57) ABSTRACT

A method of predictive assessment that merges learning and testing by teaching through repeated assessment in order to instill in a user an intuitive understanding of a concept or conceptual relationship The method makes use of an Educational Object (10) that is abstracted from an epistemic model (12). The Educational Object (10) broadly comprises a Target Object (16); a Trial Object (20); one or more Trial Controls (22); an Evaluation Function (24); and an Assessment Metric (26). The user adjusts a characteristic of the Trial Object (20) using the Trial Controls (22) in an attempt to match the characteristic with that of a Target Object (16). The Evaluation Function (24) determines the results of and updates the Trial Object (20) to reflect the user's adjustments. The Assessment Metric (26) compiles data on the user's attempts to achieve a match.

### RELATED APPLICATIONS

The present non-provisional patent application claims priority benefit with regard to all common subject matter of an earlier-filed copending provisional patent application titled EDUCATIONAL METHOD, SOFTWARE, AND SYSTEM, Ser. No. 60/510,692, filed Oct. 10, 2003 and an earlier-filed copending provisional patent application titled EDUCATIONAL METHOD, SOFTWARE, AND SYSTEM, Serial No. ______, filed Oct. 22, 2003. The identified provisional patent applications are hereby incorporated by reference into the present non-provisional patent application.

### BACKGROUND OF THE INVENTION

1. Field of the Invention

The present invention relates broadly to methods and techniques for teaching and testing. More specifically, the present invention concerns a method of predictive assessment that merges learning and testing by teaching through repeated assessment in order to instill in a user an intuitive understanding of a concept or conceptual relationship. The method makes use of an Educational Object that is abstracted from an epistemic model. Broadly, a user adjusts a characteristic of a Trial Object in an attempt to match the characteristic with that of a Target Object. An Evaluation Function determines the results of and updates the Trial Object to reflect the user's adjustments, and an Assessment Metric compiles data on the user's attempts to achieve a match.

2. Description of the Prior Art

It is often desirable or necessary to reliably teach or test understanding of a concept or conceptual relationship from an epistemic body of knowledge. Currently, however, there are no standardized mechanisms or techniques in the field of education for assessing such knowledge. Instead, an ad hoc system of testing is used that typically involves a plurality of multiple choice questions that test recognition and recollection rather than true understanding and mastery of the knowledge. Even the most sophisticated of these prior art testing techniques involves little more than regurgitation of memorized material. Furthermore, students r other test-takers have traditionally devised ways to make it appear to instructors r other evaluators that they understand concepts, even when they do not.

Due to these and other problems and disadvantages in the prior art, a need exists for an improved method of teaching and testing.

### SUMMARY OF THE INVENTION

The present invention overcomes the above-described and other problems and disadvantages in the prior art by providing a method of predictive assessment that merges learning and testing by teaching through repeated assessment. The method instills in a user an intuitive understanding, and provides assessment records that allow an evaluator to easily determine whether the user is actually learning and, if not, how best to provide individualized assistance to the user in order to achieve learning and mastery of the subject.

The method makes use of an Educational Object abstracted from an epistemic model to provide an assessment and learning tool that models a concept or a simple or complex conceptual relationship. The Educational Object broadly comprises a Target Object; one or more Target Controls; a Trial Object; one or more Trial Controls; an Evaluation Function; and an Assessment Metric. The Target Object represents a result or other goal that the user must achieve by developing an understanding of the underlying concept or conceptual relationship. The Target Controls allow the evaluator to initially configure the characteristics of the Target Object. The Trial Object is the user's vehicle for conducting predictive experimentation in order to learn and demonstrate knowledge of the concept or conceptual relationship by adjusting the characteristics of the Trial Object to match those of the Target Object. The Trial Controls allow the user to make these adjustments to the characteristics of the Trial Object. The Evaluation Function receives and evaluates the adjustments to determine whether a successful match has been achieved. The Evaluation Function also updates or changes the Trial Object to reflect the adjustments so that the user can see the effects of the adjustments. If the result is not a match, then another adjustment is called for, with the user's next adjustment being applied to the previously adjusted Trial Object. The Assessment Metric is a record of the user's performance in attempting to match the Target and Trial Objects. The Assessment Metric may include such data as, for example, the number of attempts required by the user to achieve a match, the elapsed time, and the particular adjustments or pattern of adjustments employed by the user.

In use and operation, the characteristics of the Target Object are first configured, the user is presented with the Target Object, and the predictive assessment process begins. The user is allowed to make an adjustment to the Trial Controls in an attempt to match the characteristics of the Trial Object with those of the Target Object. Once the user indicates he or she is finished with an adjustment, the result of the adjustment is revealed by changing or otherwise updating the Trial Object to reflect the adjustment. If the result is not a match, then the user is allowed to make another adjustment. This next adjustment is facilitated by the user visually or otherwise comparing the adjusted Trial Object with the Target Object, and taking note of the effect of the previous adjustment. During this process of adjustment and readjustment, assessment data of the user's attempts to match the Target and Trial Objects is compiled.

After one or more iterations of this process of adjustment, assessment, and readjustment, the user should begin to develop an intuitive understanding of the concept or conceptual relationship involved and be able to predict the results of further adjustments to achieve a match with the Target Object. When the user can match the Trial Object to the Target Object within a pre-established acceptable amount of time and using no more than a pre-established maximum number of adjustments, then the user is considered to understand and be proficient in the task.

Educational Objects can be authored or created to model a variety of concepts or conceptual relationships. Possibilities include, for example, teaching Ohm's Law and wire gauge selection wherein the user develops an intuitive understanding of Ohm's Law and uses this knowledge to make appropriate wire gauge selections; teaching a process of color matching wherein the user adjusts color components of the Trial Object until its color matches the color of the Target Object; or teaching a process of spatial or geometric recognition wherein the user adjusts side, length, and angle components of the Trial Object until its shape matches the shape of the Target Object.

Thus, it will be appreciated that the present invention provides a number of substantial advantages over the prior art, including, for example, merging learning and assessment to provide dramatically improved understanding of essential concepts. Testing has shown that the method of the present invention allows users to learn essential concepts in approximately one quarter of the time required by traditional teaching techniques. Furthermore, the method of the present invention also advantageously provides a standardized mechanism for evaluating user understanding or performance; allows for criterion referenced assessment using multiple configurations of the Educational Object; and allows for team predictive performance assessment.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a high-level representation of a process of creating an Educational Object based upon an epistemic model, wherein the Educational Object is a primary component in the method of the present invention;

FIG. 2 is a block diagram showing components of a preferred embodiment of the Educational Object of the present invention;

FIG. 3 is a flowchart of steps involved in practicing a preferred embodiment of the method of the present invention;

FIG. 4 is a block diagram showing certain components of the Educational Object adapted for team predictive performance assessment; and

FIG. 5 is a depiction of a user interface associated with an exemplary and illustrative Educational Object specifically adapted for teaching or testing concepts and conceptual relationships related to Ohm's Law and wire gauge selection.

### DETAILED DESCRIPTION OF A PREFERRED EMBODIMENT

With reference to the figures, a method of predictive assessment is described, shown, and otherwise disclosed in accordance with a preferred embodiment of the present invention. Broadly, the method merges learning and testing by teaching through repeated assessment. Because the method may be used to merely teach, teach and test, or merely test, as used herein “evaluator” should be understood to refer to any person, machine, or other entity (e.g., teacher, instructor, supervisor, proctor, computer) with control over the process of predictive assessment, while “user” should be understood to refer to any person, machine, or other entity (e.g., student, test-taker, candidate, robot or other machine having artificial intelligence or other learning capability) undergoing the process of predictive assessment. In that light, the method provides a technique for instilling within the user an intuitive understanding, and provides assessment records that allow the evaluator to easily determine whether the user is actually learning and, if not, how best to provide individualized assistance to the user in order to achieve learning and mastery of the subject.

Intuition, it will be appreciated, is related to self-awareness, and is a way of gathering data that draws on first-hand experience. At the same time, intuition provides a way of making meaning—a whole-making reasoning mode. Intuition is the utmost contextual phenomena: the intuitive understanding of a focal event is based upon the background knowledge that frames it and endows it with a feeling of rightness. While non-conscious processes are at work, these do not contradict rationality but rather underpin it.

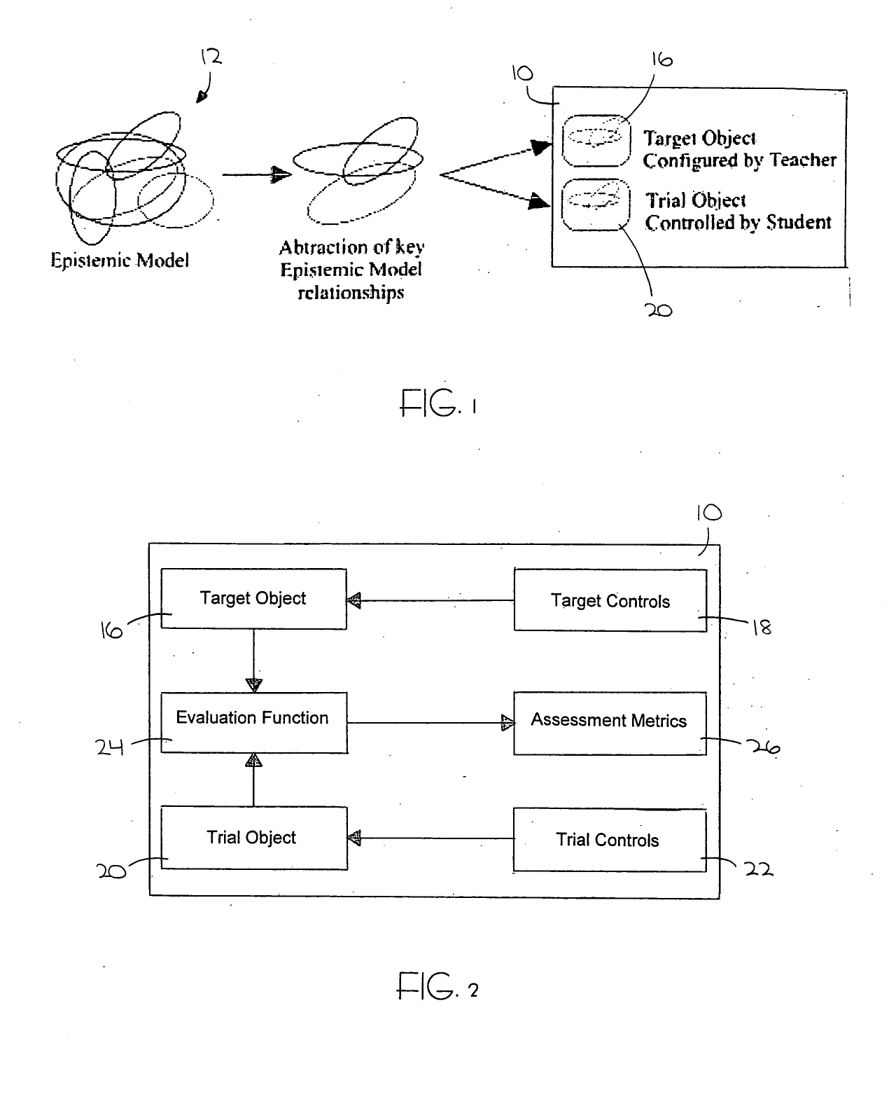

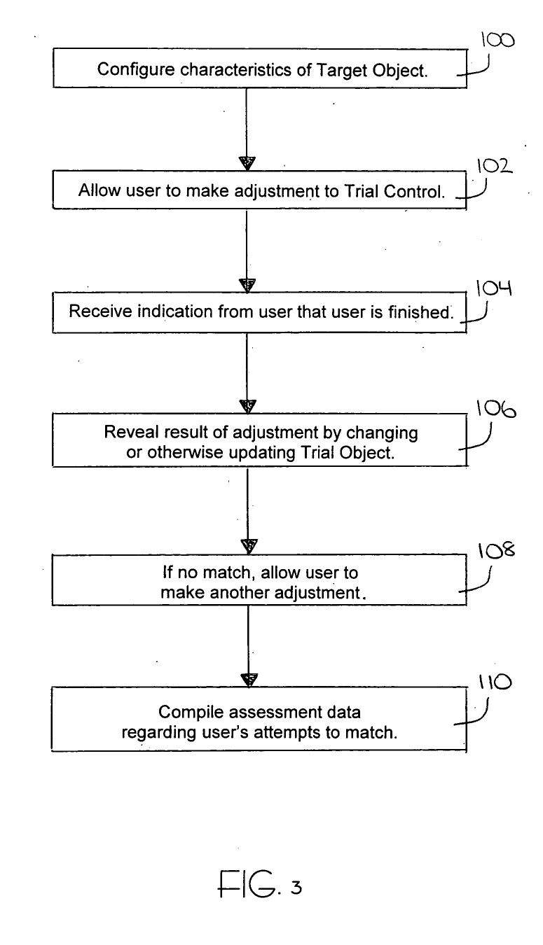

Referring particularly to FIGS. 1 and 2, the method makes use of an Educational Object 10 abstracted from an epistemic model 12 to provide an assessment and learning tool that models a concept or a simple or complex conceptual relationship. The conceptual relationship will typically involve a concept, value, or function that is either modified by or that modifies another concept, value, or function. Because the Educational Object 10 is an abstraction of the epistemic model 12, it allows for assessing both the user's understanding of the concept or conceptual relationship and the user's cognitive processes in learning the concept or conceptual relationship. Thus, both the user's grasp of the information and their ability to “figure out how it works” are assessed. Furthermore, because epistemic models 12 are universally accepted, performance can be consistently measured, and the Educational Object 10 establishes standardized assessment criteria.

Scientists and researchers use real-world epistemic models to further human knowledge in specific disciplines. The electronic form of the epistemic models 12 used in the Educational Objects 10 of the present invention allow the models 12 to be edited, revised, or automatically generated. The Educational Objects 10 can provide the scientists and researchers with large data samples that allow for evaluating the epistemic models 12 themselves. Using artificial intelligence technology with the Educational Objects 10 may allow for improving or refining the epistemic models 12 to further advance epistemic knowledge.

It should be noted that the present invention is not limited to epistemic models that mimic the real world. Epistemic models can be created that correspond to virtual or imaginary worlds in order to study these worlds and, perhaps, better understand our own. Thus, epistemic models can be created that define knowledge or fields of study for which there is no real-world counterpart. By incorporating these models into Educational Objects 10, the user can master cognitive processes necessary to adapt to fictitious or otherwise unknown worlds or environments. This feature has broad application in such diverse fields as exploration, wherein explorers are able to gain experience and insight into living and working in unusual environments, and cognitive therapy for mental patients.

The epistemic models 12 may be built by human educators or other experts or generated substantially automatically in accordance with an appropriate algorithm. An electronic model of metaphysical intelligence may be used to generate new epistemic models which are difficult for humans to generate. Thus, the Educational Objects 10 can be generated substantially automatically from the epistemic models 12 which are themselves generated substantially automatically from metaphysical models.

It will also be appreciated that in the process of creating or updating an Educational Object 10, errors in the current epistemic model 12 may be discovered. Thus, the Educational Object 10 allows the epistemic model 12 to be revised and updated.

The method is preferably implemented in a computer program preferably written in REBOL (Relative Expression-Based Object Language). Alternatively, any suitable or otherwise desirable programming language may be used. REBOL, however, was designed specifically for distributed Internet applications and data exchange across all platforms. REBOL/IOS provides an X-Internet (“executable Internet”) framework that allows the Educational Object 10 to be distributed easily across networks and into classrooms or organizations or used as a platform for distance learning. REBOL/IOS X-Internet software provides several advantages over other platforms, including, for example, that the Education Object 10 can be written as a tiny application called a “reblet”, distributed instantly, and connected for real-time interaction between multiple users. Furthermore, X-Internet technology ensures that even when widely-distributed the Educational Object 10 is responsive and secure, and that only properly authenticated users are able to access a closed group. The X-Internet also provides REBOL with a universal messaging language between machines that includes data, function, application, and communication compatibility across a large number of computer platforms. This X-Internet capability lends itself particularly well to machine learning and artificial intelligence activities.

Distributed configuration management is an advantage provided by the Educational Object 10 using REBOL and its X-Internet solution. The X-Internet provides a simple and convenient mechanism for configuration management. When an Educational Object 10 is authored, or its underlying epistemic model 12 is changed, the changes are published such that users and evaluators who have access to that Educational Object 10 receive the revision via the X-Internet. As desired, previous versions of the epistemic model 12, Educational Object 10, assessment records, or other data can be retrieved.

It will be appreciated that the method of the present invention may be implemented in a variety of ways and scales. For example, the method may be implemented for use in a traditional classroom environment, or to facilitate distance learning across a wide area network (WAN) such has the Internet. Thus, the present invention could be adopted as a mechanism for both teaching and certifying professionals or tradesmen, such as electricians. With that in mind, the computer program may, for example, be stored on, executed by, and accessed from the same computing device, or alternatively, may be stored on and executed in whole or in part by a remote first computing device (e.g., a server) and accessed via a wide or local area network by the user using a second computing device (e.g., a personal desktop or laptop computer or a hand-held device such as a personal digital assistant).

The Educational Object 10 broadly comprises a Target Object 16; one or more Target Controls 18; a Trial Object 20; one or more Trial Controls 22; an Evaluation Function 24; and an Assessment Metric 26. The Target Object 16 represents a result or other goal that the user must achieve by developing an understanding of the underlying concept or conceptual relationship. The Target Controls 18 allow the evaluator to initially configure the characteristics of the Target Object 16. Alternatively, these characteristics can be randomly generated, requiring no action by the evaluator. The Trial Object 20 is the user's vehicle for conducting predictive experimentation in order to learn and demonstrate knowledge of the concept or conceptual relationship by adjusting the characteristics of the Trial Object 20 to match those of the Target Object 16. The Trial Controls 22 allow the user to make these adjustments to the Trial Object 20. Thus, the nature of the Trial Controls 22 will depend upon the nature of the Educational Object and of the concept or conceptual relationship involved, but may include, for example, any number or combination of real or virtual switches, buttons, sliding switches, or data input fields. The Evaluation Function 24 receives and evaluates the adjustments made by the user to determine whether a successful match has been achieved. The Evaluation Function 24 also updates or changes the Trial Object 20 to reflect the adjustments so that the user can see the effects the adjustments. If the result is not a match, then another adjustment is called for, with the user's next adjustment being applied to the previously adjusted Trial Object 20.

The Assessment Metric 26 is a record of the user's performance in attempting to match the Target and Trial Objects 16,20. The Assessment Metric 26 may include such data as, for example, the number of attempts required by the user to achieve a match, the elapsed time, and the particular adjustments or pattern of adjustments employed by the user (e.g., high, low, high, low, match, or high, high, high, high, match). This data can be presented in text or graph form, as desired, and can be used to determine additional useful information, including, for example, the cognitive processes employed by the user during the process. This data can also be used to validate the effectiveness all types of learning methods and educational strategies. Suggesting new educational practices as well as new pedagogies.

Referring also to FIG. 3, in use and operation the method proceeds broadly as follows. The characteristics of the Target Object are first configured, either by the evaluator using the Target Controls or automatically, as depicted in box 100. If manually configured, the Target and Trial Objects 16,20 are communicated from the evaluator's computer to the user's computer via X-Internet delivery using file-set synchronization and messaging.

The user is then presented with the Target Object 16 and the predictive assessment process begins. The user is allowed to make an adjustment to the Trial Controls 22 in an attempt to match the characteristics of the Trial Object 20 with those of the Target Object 16, as depicted in box 102. Once the user indicates he or she is finished with an adjustment, as depicted in box 104, the result of the adjustment is revealed by changing or otherwise updating the Trial Object 20 to reflect the adjustment, as depicted in box 106. If the result is not a match, then the user is allowed to make another adjustment, as depicted in box 108. The result of the previous adjustment remains presented, and this next adjustment is applied to the previously adjusted Trial Object 20 and not to the Trial Object 20 as it was initially generated. The next adjustment is facilitated by the user visually or otherwise comparing the adjusted Trial Object 20 with the Target Object 16 and taking into consideration the effects of the previous adjustment. During this process of adjustment and readjustment, assessment data of the user's attempts to match the Target and Trial Objects 16,20 is compiled, as depicted in box 110.

After one or more iterations of this process of adjustment, assessment, and readjustment, the user should begin to develop an intuitive understanding of the concept or conceptual relationship involved and be able to predict the results of further adjustments to achieve a match with the Target Object 16. When the user can match the Trial Object 20 to the Target Object 16 within a pre-established acceptable amount of time and using no more than a pre-established maximum number of adjustments, then the user is considered to understand and be proficient in the task.

As desired, the user may be provided with any appropriate real or virtual tools or resources necessary to achieve or assist in achieving the match. These tools might include, for example, calculators, templates, protractors, and graphing tools. The user's use of these tools is preferably recorded and incorporated into the assessment statistics and other data so that the evaluator can later review such use in order to determine where any mistakes may have occurred.

It will be appreciated that the method of the present invention advantageously allows for criterion referenced assessment. Criterion referenced assessment requires that specific outcomes be met by a large population of test-takers using multiple assessment instruments. The criterion exists external to the assessments that reference it. More specifically, commonly accepted epistemic models establish the criterion that the Educational Objects 10 reference. Multiple configurations of the Educational Object 10 meet the multiple assessment requirement. The same Educational Object 10 can be used by many users, thereby creating a criterion referenced assessment.

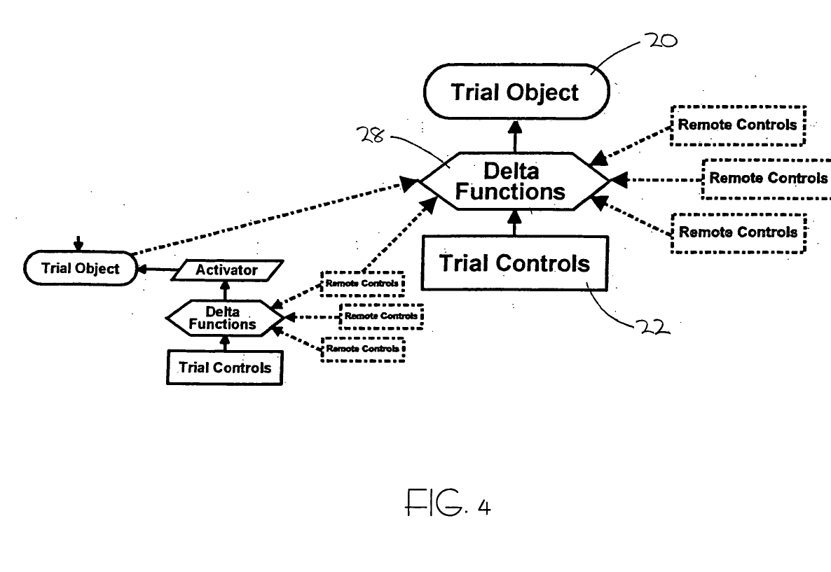

Referring to FIG. 4, it will also be appreciated that the present invention allows for team predictive performance assessment. Predictive performance assessment for teams involves multiple users working to achieve a single objective or multiple related objectives. More specifically, the method can be used to test teams by linking multiple users to the same Educational Object 10, multiple instances of the same Educational Object 10 in different configurations, or multiple Educational Objects 10 that affect each other. Delta Functions 28 placed between the Trial Controls 22 and the Trial Object 20 allow attributes of the Trial Object 20 to be controlled by multiple users. The evaluator controls the number of users, the number and configuration of Target Objects 16, and the Assessment Metrics 26 to be displayed and collected.

The Delta Functions 28 permit team assessment by allowing the Trial Controls 22 of any similar Educational Object 10 to control the attributes of another or of several other Educational Objects 10. Target and Trial Objects 16,20 can be configured to control other objects through these Delta Functions 28, creating one-to-many, many-to-one, and many-to-many relationships. Any X-Internet or other convenient method of linking Trial Controls 22 to the Delta Functions 28 can be employed. Assessment data can be collected for individual team members as well as for the aggregate team. Thus, any configuration of identical, similar, or different Educational Objects 10 can be related through the Delta Functions 28, thereby establishing a platform for standardized team assessment.

Also, the present invention may be used as a mechanism for enhancing teamwork. Educational Objects 10 deployed on an X-Internet collaboration system create a team environment that teaches teamwork through repeated assessment. When combined with individual Educational Objects 10, team members can learn key concepts concurrently with learning teamwork to achieve a given set of objectives. Team effectiveness assessment by Educational Objects 10 creates data for evaluating and improving the teamwork. Team and individual member metrics can provide valuable research data for such diverse areas as artificial intelligence, collaborative learning, team building, group interaction, and sociological studies.

It will also be appreciated that teaching and learning through Educational Objects 10 can be incorporated into scientific experimentation in order to shorten the “time-to-teach” from current research being conducted at various research institutions. Educational Objects 10 can be generated and updated in real-time integrating the latest research data, hypotheses, or theories. Educational Objects 10 can be used as dissemination tools and experimental verification utilities. Users and evaluators at all levels can make immediate use of research Educational Objects 10 as they are updated across the X-Internet.

As mentioned, the method of the present invention allows for online delivery of education through X-Internet distribution of the Educational Objects 10. The X-Internet consists of executable code distributed across networks and digital constructs passed across networks between applications providing functional peer-to-peer real-time interactivity. Educational Objects 10, when distributed through X-Internet systems, create a medium of communication between evaluators and users. The aforementioned Delta Functions 28 allow multiple users to control the same Target and Trial Objects 16,20. The resulting changes allow for responses and communication is established which constitutes online delivery of education.

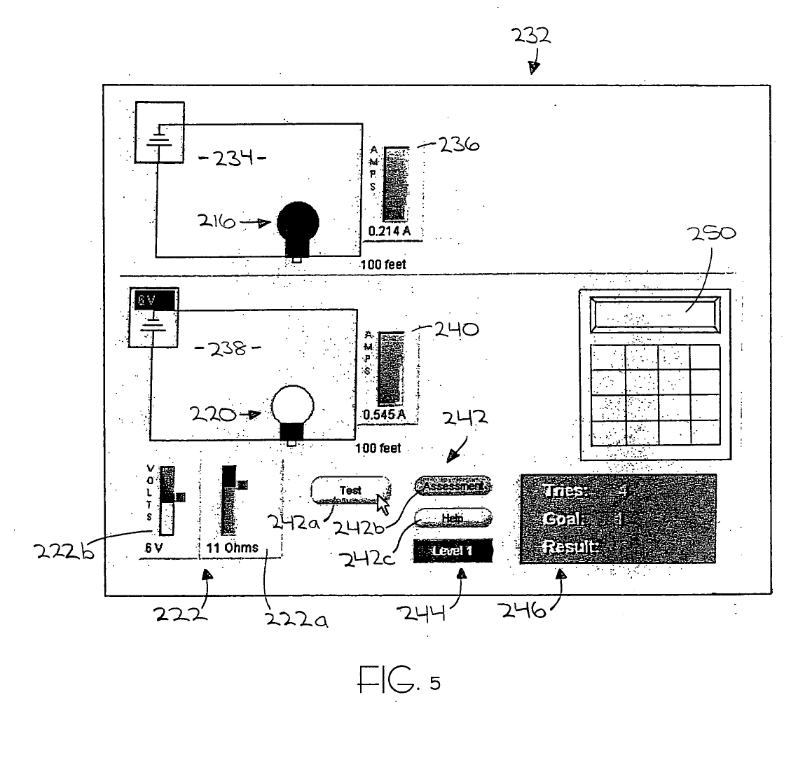

The method of the present invention is adaptable to teach or test a wide variety of different concepts or conceptual relationships. Referring also to FIG. 5, what follows is a non-limiting description of an exemplary and illustrative application of the method to teach and test electrical knowledge.

It is necessary for practitioners of the electrical arts to master certain laws of electricity, including, for example, Ohm's law and its impact on the selection of proper wire gauges for electrical circuits. If the gauge is too large, unnecessary expense results; if the gauge is too small, excessive voltage drop can result which may damage motors or other devices in the circuit, and, if the current exceeds the ampacity of the wire, electrical fires can result. Use of the present invention all but assures that the user will become familiar with Ohm's Law and its application to electrical circuits, including mastering wire gauge selection, even for circuits that will be subjected to any of a number of environmental variables (e.g., high or low ambient temperatures). This dramatically improves understanding and enhances certification and licensing. In short, the user learns to accurately predict the effects or results of using different wire gauges in the circuit using knowledge of Ohm's Law and the NEC code book as they attempt to match the target wire gauge.

Referring also to FIG. 5, preliminarily one or more interfaces are created to communicate components of the Educational Object 10 to the evaluator and the user. With regard to the user's interface 232, at least two different modes are contemplated: Assessment Mode in which the process of predictive assessment takes place, and Interactive Mode in which online help is displayed or otherwise provided. Preferably, Interactive Mode can be disabled by the evaluator, as desired.

In this example, there are preferably three levels of assessment. Level 1 Assessment Mode allows the user to select and adjust voltage and resistance values in an attempt to match a target current value of the Target Object 216. Level 2 Assessment Mode allows the user to select and adjust load and wire gauge values in an attempt to match target current, voltage, and wire length values of the Target Object 216. Level 3 Assessment Mode allows the user to adjust voltage and gauge values in an attempt to match target current, power load, and temperature values of the Target Object 216. Thus, the teaching and assessment process proceeds from theory in Level 1 to practical application in Level 3.

In Level 1 Assessment Mode, the user is present with a first circuit diagram 234 including the Target Object 216; a first virtual amperage gauge 236; a second circuit diagram 238 including the Trial Object 220; a second virtual amperage gauge 240; the Trial Controls 222; three virtual buttons 242; a level indicator 244; and an assessment panel 246. The first and second circuit diagrams 234,238 are identical, each being a simple closed loop including a virtual voltage source and the Target Object 216 or Trial Object 220, respectively, which are, in this example, virtual lightbulbs. The brightness of the light bulbs depends on the amperage of the electric current within the electric circuit. The first and second virtual amperage gauges 236,240 provide more quantitative indications of the amperage in each electric circuit. The Trial Controls 222 comprise a first virtual sliding switch 222a that controls and allows for adjusting the electrical resistance (in Ohms) of the light bulb, and a second virtual sliding switch 222b that controls and allows for adjusting the DC voltage (in Volts) applied to the light bulb. The three virtual buttons 242 include a Test button 242a selectable by the user to cause the computer program to call the Evaluation Function 24 to assess any adjustment made by the user to the Trial Controls 222 and to update the Trial Object 220 to reflect such adjustment; an Assessment button 242b selectable by the user to call the Assessment Metric 26 to cause a record of the user's performance to be displayed in the assessment panel 246; and a Help button 242c selectable by the user to cause the interface 232 to switch to Interface Mode and display online help in the form of visual, audible, or other assistance for using the interface 232. The level indicator 244 communicates which level the of assessment is being performed. The assessment panel 246 displays the aforementioned record of the user's performance, including the number of tries required to reach a match.

In this example, an additional resource, a virtual calculator 250, is provided for the user for performing Ohm's Law calculations.

As mentioned, the Interactive Mode provides online help for the user. This help may include, for example, a simulation of the process that occurs in the Assessment Mode. Interactive Mode also provides a non-assessment feature that allows the user to experience and familiarize him or herself with the process occurring in the Assessment Mode without being assessed. With this feature, adjustments made to the Trial Controls 222 are reflected in the Target Object 216 in real-time, which allows the user to gain a preliminary understanding of the effects of different manipulations of the Trial Controls 222 before entering the Assessment Mode and having his or her performance assessed.

In this example, there are preferably three levels of non-assessment interactivity. Level 1 Interactive Mode presents an interface that is similar or identical to the interface 232 presented in Level 1 Assessment Mode except that, as mentioned, the user's adjustments are reflected in real-time (the Test button 242a has no effect in this mode). This allows the user to explore the implications and effects of Ohm's Law.

Level 2 Interactive Mode presents an interface that is similar or identical to the interface presented in Level 2 Assessment Mode except that, as mentioned, the user's adjustments are reflected in real-time. Thus, the user is provided with load, wire gauge, wire length, and voltage controls. This allows the user to explore the effect of Ohm's Law on voltage drop.

Level 3 Interactive Mode presents an interface that is similar or identical to the interface presented in Level 3 Assessment Mode except that, as mentioned, the user's adjustments are reflected in real-time. Thus, the user is provided with current, load, wire gauge, wire length, voltage, and temperature controls. This effectively provides the user with a wire gauge “calculator” that allows him or her to explore the varying relationships between a number of real-world factors and considerations.

As mentioned, it will be appreciated that Educational Objects 10 can be authored or created to model a variety of concepts or conceptual relationships. In addition to the Ohm's Law and wire gauge example described above, other possibilities include, for example, teaching a process of color matching wherein the user adjusts color components of the Trial Object until its color matches the color of the Target Object, or teaching a process of spatial or geometric recognition wherein the user adjusts side, length, and angle components of the Trial Object until its shape matches the shape of the Target Object.

As earlier indicated, the present invention may be used to teach and test machines having artificial intelligence or other learning capability. A machine user may interact with the Educational Object 10 in any one of a variety of ways, including via the various interfaces or via direct communication with the underlying computer program. Broadly, the machine user adjusts the Trail Controls 22, identifies the resulting change in the Trial Object 20, and then, if necessary, again adjusts the Trial Controls 22 until the Trial Object 20 matches the Target Object 16.

The mechanism by which the machine user identifies the resulting change in the Trial Objects 20 will depend on such factors as the nature of the Trial Object 20, the nature of the characteristic being adjusted, and the capabilities of the machine user. The machine user might, for example, “observe” the change using any suitable visual sensor or receptor technology. Throughout the process, the artificial intelligence of the machine user adjusts, as necessary, its understanding in response to feedback regarding the relationship underlying the adjustment and the resulting change, and thereby learns the proper relationship in substantially the same manner as a human user.

Furthermore, just as the Assessment Metric 26 can provide a useful record of a human user's performance, it can also provide a record of the machine user's performance that can yield useful data for studying and evaluating the artificial intelligence or other learning capability employed by the machine user. This is particularly advantageous as there are many machine learning paradigms, and, prior to the present invention, there existed no substantially automatic way to assess the ability of machines to think and learn or to assess these various paradigms of machine learning.

From the preceding discussion it will be appreciated that the present invention provides a number of substantial advantages over the prior art, including, for example, merging learning and assessment to provide dramatically improved understanding of essential concepts. Testing has shown that the method of the present invention allows users to learn essential concepts in approximately one quarter of the time required by traditional teaching techniques. Furthermore, the method of the present invention also advantageously provides a standardized mechanism for evaluating user understanding or performance; allows for criterion referenced assessment using multiple configurations of the Educational Object; and allows for team predictive performance assessment.

Although the invention has been described with reference to the preferred embodiments illustrated in the attached drawings, it is noted that equivalents may be employed and substitutions made herein without departing from the scope of the invention as recited in the claims. It will be appreciated, for example, that the specific details of each Educational Object and its various components will vary substantially depending on the concept or conceptual relationship involved.

Having thus described the preferred embodiment of the invention, what is claimed as new and desired to be protected by Letters Patent includes the following:

1. A method of predictive assessment, the method comprising the steps of:
(a) providing an educational object that is based upon a conceptual relationship, wherein the educational object includes—
a target object representing a goal, wherein the target object has a target object characteristic related to the conceptual relationship,
a trial object having a trial object characteristic, wherein the trial object characteristic is adjustable by a user, and
a trial control adapted to allow for adjusting the trial object characteristic;
(b) allowing the user to make an adjustment to the trial object characteristic using the trial control in an attempt to match the trial object characteristic to the target object characteristic;
(c) evaluating the adjusted trial object characteristic to determine whether the user's attempt to match the trial object characteristic to the target object characteristic was successful; and
(d) changing the trial object to reflect the adjusted trial object characteristic.

2. The method as set forth in claim 1, wherein the education object is abstracted from an epistemic model

3. The method as set forth in claim 1, wherein the educational object is implemented using a computer program, and the target object, the trial object, and the trial controls are virtual in nature.

4. The method as set forth in claim 3, wherein the educational object is communicated over a wide area network to the user.

5. The method as set forth in claim 1, further including the step of repeating step (b) and allowing the user to make a number of adjustments until the trial object characteristic matches the target object characteristic.

6. The method as set forth in claim 1, further including the step of compiling an assessment metric of data related to the user's attempt to match the trial object characteristic to the target object characteristic.

7. The method as set forth in claim 6, wherein the assessment metric includes a number of adjustments made by the user, an elapsed time, and the adjustments made.

8. The method as set forth in claim 1, wherein the educational object further includes a target control allowing for configuring the target object characteristic, and the method further includes the step of allowing an evaluator to use the target control to configure the target object characteristic.

9. The method as set forth in claim 1, further including the step of providing a resource to the user that can assist in matching the trial object characteristic to the target object characteristic.

10. The method as set forth in claim 1, further including the step of providing a non-assessment mode that allows the user to gain familiarity with the educational object and the conceptual relationship, wherein this step includes—
allowing the user to adjust the trial object characteristic using the trial control in an attempt to match the trial object characteristic to the target object characteristic; and
changing in real-time the trial object to reflect the adjustments made using the trial control.

11. The method as set forth in claim 1, further including the step of performing criterion referenced assessment using multiple configurations of the educational object.

12. The method as set forth in claim 1, further including the step of providing a delta function for receiving a plurality of adjustments from a plurality of users and for changing the trial object to reflect the plurality of adjustments.

13. A method of predictive assessment for teaching and testing a user regarding knowledge of a conceptual relationship, the method comprising the steps of:
(a) providing an educational object that is abstracted from an epistemic model that addresses the conceptual relationship, wherein the educational object includes—
a target object representing a goal, wherein the target object has a target object characteristic related to the conceptual relationship,
a trial object having a trial object characteristic, wherein the trial object characteristic is adjustable by the user, and
a trial control adapted to allow for adjusting the trial object characteristic;
(b) allowing the user to make an adjustment to the trial object characteristic using the trial control in an attempt to match the trial object characteristic to the target object characteristic;
(c) evaluating the adjusted trial object characteristic to determine whether the user's attempt to match the trial object characteristic to the target object characteristic was successful;
(d) changing the trial object to reflect the adjusted trial object characteristic;
(e) repeating step (b) and allowing the user to make a number of adjustments until the trial object characteristic matches the target object characteristic; and
(f) compiling an assessment metric of data related to the user's attempts to match the trial object characteristic to the target object characteristic.

14. The method as set forth in claim 13, wherein the educational object is implemented using a computer program, and the target object, the trial object, and the trial controls are virtual in nature.

15. The method as set forth in claim 14, wherein the educational object is communicated over a wide area network to the user.

16. The method as set forth in claim 13, wherein the assessment metric includes a number of adjustments made by the user, an elapsed time, and the adjustments made.

17. The method as set forth in claim 13, wherein the educational object further includes a target control allowing for configuring the target object characteristic, and the method further includes the step of allowing an evaluator to use the target control to configure the target object characteristic.

18. The method as set forth in claim 13, further including the step of providing a resource to the user that can assist in matching the trial object characteristic to the target object characteristic.

19. The method as set forth in claim 13, further including the step of providing a non-assessment mode that allows the user to gain familiarity with the educational object and the conceptual relationship, wherein this step includes—
allowing the user to adjust the trial object characteristic using the trial control in an attempt to match the trial object characteristic to the target object characteristic; and
changing in real-time the trial object to reflect the adjustments made using the trial control.

20. The method as set forth in claim 13, further including the step of performing criterion referenced assessment using multiple configurations of the educational object.

21. The method as set forth in claim 13, further including the step of providing a delta function for receiving a plurality of adjustments from a plurality of users and for changing the trial object to reflect the plurality of adjustments.

22. A method of predictive assessment for teaching and testing a user regarding knowledge of a conceptual relationship, the method comprising the steps of:
(a) providing a computer-based educational object for communication to the user over a network, wherein the educational object is abstracted from an epistemic model that addresses the conceptual relationship, wherein the educational object includes—
a virtual target object representing a goal, wherein the virtual target object has a target object characteristic related to the conceptual relationship,
a virtual target control allowing for configuring the target object characteristic,
a virtual trial object having a trial object characteristic, wherein the trial object characteristic is adjustable by the user, and
a virtual trial control adapted to allow for adjusting the trial object characteristic;
(b) allowing the user to make an adjustment to the trial object characteristic using the virtual trial control in an attempt to match the trial object characteristic to the target object characteristic;
(c) evaluating the adjusted trial object characteristic to determine whether the user's attempt to match the trial object characteristic to the target object characteristic was successful;
(d) changing the trial object to reflect the adjusted trial object characteristic;
(e) repeating step (b) and allowing the user to make a number of adjustments until the trial object characteristic matches the target object characteristic; and
(f) compiling an assessment metric of data related to the user's attempts to match the trial object characteristic to the target object characteristic, wherein the assessment metric includes a number of adjustments made by the user, an elapsed time, and the adjustments made.

23. The method as set forth in claim 22, further including the step of providing a resource to the user that can assist in matching the trial object characteristic to the target object characteristic.

24. The method as set forth in claim 22, further including the step of providing a non-assessment mode that allows the user to gain familiarity with the educational object and the conceptual relationship, wherein this step includes—
allowing the user to adjust the trial object characteristic using the trial control in an attempt to match the trial object characteristic to the target object characteristic; and
changing in real-time the trial object to reflect the adjustments made using the trial control.

25. The method as set forth in claim 22, further including the step of performing criterion referenced assessment using multiple configurations of the educational object.

26. The method as set forth in claim 22, further including the step of providing a delta function for receiving a plurality of adjustments from a plurality of users and for changing the trial object to reflect the plurality of adjustments.
